(19) United States
(12) Patent Application Publication
(10) Pub. No.: US 2025/0135429 A1
(43) Pub. Date: May 1, 2025

(54) AUTOMATED CONTROL SYSTEM AND METHOD AND CHEMICAL PARK

(71) Applicant: BASF SE, Ludwigshafen am Rhein (DE)

(72) Inventor: Michael PFAFFMANN, Ludwigshafen am Rhein (DE)

(21) Appl. No.: 18/685,155

(22) PCT Filed: Aug. 17, 2022
(86) PCT No.: PCT/EP2022/072965

§ 371 Date: Feb. 20, 2024

(30) Foreign Application Priority Data
Aug. 20, 2021 (EP) 21192382.6

(51) Int. Cl. B01J 19/00

(52) U.S. Cl. CPC B01J 19/0033; B01J 2219/00207; B01J 2219/00218; B01J 2219/00231

(57) ABSTRACT

Provided is an automated control system for controlling production in one or more chemical plants comprising: a central acquisition device that acquires a certificate indicating raw material properties of an inbound raw material and automatically derives the raw material properties from the certificate; a central management device that compares the raw material properties with corresponding pre-stored raw material specifications and generates a validation result indicating acceptance or rejection of the inbound raw material; and one or more process control systems for controlling respective chemical reactions in the chemical plants that, if the validation result indicates acceptance of the inbound raw material, control the corresponding chemical plant to feed the inbound raw material. A corresponding automated control method and a chemical park are also provided.

### TECHNICAL FIELD

The present invention relates to the field of control systems for chemical plants, and, more particularly, to an automated control system for controlling production in a number of chemical plants, a corresponding automated control method, and to a chemical park comprising the auto-mated control system.

### TECHNICAL BACKGROUND

Chemical process industries raw materials are used to produce products, in particular by chemical reactions. The products rely on the physico-chemical properties of the raw material. For the production process consistent physico-chemical properties of the raw materials are decisive. Variations in physico-chemical properties of the raw materials may lead to quality fluctuations of the produced product, failures in the chemical plant and or accidents. For the quality of produced products it is crucial that the raw materials meet specifications of physico-chemical properties.

Thus there is a need for a robust, efficient, ecological friendly way of controlling chemical plants. based on the quality of raw materials.

### SUMMARY

Under a first aspect, the object is solved by an automated control system for controlling production in a number of chemical plants. The control system comprises a central acquisition device configured to: acquire a certificate indicating a number of raw material properties of an inbound raw material that has been delivered to a site of the number of chemical plants and derive the raw material properties from the human-readable certificate. The control system further comprises a central management device configured to: compare the derived raw material properties with a corresponding one of a number of raw material specifications stored in a database of the central management device, and generate a validation result indicating acceptance or rejection of the inbound raw material. The control system further comprises a number of process control systems for controlling a respective chemical reaction to be conducted in a respective one of the chemical plants, the process control systems being configured to: if the validation result indicates acceptance of the inbound raw material, control the corresponding chemical plant to start feeding the inbound raw material.

Accordingly, a decision whether to accept or reject the inbound raw material may be made automatically based on an automated analysis of the raw material properties derived from the certificate. The decision may be made only once, i.e., centrally for the entire site of the chemical plants are. Thereby, advantageously, human intervention is reduced, the handling of inbound raw material at the site can be streamlined, and it may be possible to achieve higher throughput, improved first time pass rates, better product quality, and better global insight and analysis. Higher first time pass rates may reduce waste.

In particular, the term “certificate” may refer to a physical and/or digital representation of information that indicate the raw-material properties. For example, said information may be unstructured information. For example, the certificate may be a human-readable representation of said information.

In particular, the term “certificate indicating raw material properties” may refer to a physical and/or digital representation of information that comprises the raw material properties and/or comprises information on how to obtain the raw material properties.

The certificate indicating raw material properties of the inbound raw material may also be called “inbound certificate”.

In particular, any physical or digital representation of information may constitute an inbound certificate if it allows automated extraction of the raw material properties and/or of an information on how to obtain the raw material properties with a sufficiently high precision (with a sufficiently low error rate) for the intended technical purpose of accepting or rejecting the inbound raw material.

More particularly, a so-called Certificate of Analysis in paper or electronic form is one example of a certificate. Other examples of certificates include e-mails, QR codes, data electronically submitted via an Application Programming Interface (API), and the like.

Accordingly, “deriving” the raw material properties may refer to extracting a machine-readable representation of the raw material properties from the information represented by the certificate and/or to obtaining the machine-readable representation of the raw material properties using information, such as a hyperlink, that is extracted from the human-readable certificate.

In particular, the raw material properties may be derived automatically, such as for example through a computerized process.

The raw material properties may be physico-chemical properties of the raw material that are obtainable from the raw material by way of analysis.

Furthermore, the raw material properties may also comprise sustainability management data, such as a carbon dioxide footprint, adherence of the material to a particular requirement such as “kosher” or “vegan”, and the like.

In particular, the “raw material specifications” may comprise structured data that specifies a set point value and a tolerance range for some or all of the raw material properties.

In particular, the “validation result” is generated based on a result of said comparing of the raw-material properties with the raw material specifications. For example, the validation result may be generated based on whether the raw material properties are within the tolerance range specified by the raw material specifications.

In particular, the “validation result” may be digital data comprising an indication as to whether the raw material is accepted for use in the number of chemical plants. Optionally, the validation result” may comprise further data derived from the raw material properties, such as a type of the raw material, a deviation of some or all of the raw material properties from a set point value specified by the raw material specifications, and the like.

In particular, the expression “corresponding chemical plant” in “control the corresponding chemical plant to start feeding the inbound raw material” refers to those one or more chemical plants in which a chemical reaction is to be conducted that uses the accepted inbound raw material as an educt.

In particular, for a given inbound raw material, which may be a raw material that may serve several different purposes, the database may store more than one corresponding raw material specification. For example, a first one of the chemical plants may require the inbound raw material to meet a first raw material specification, such as raw material of a specific minimum-required grade. A second one of the chemical plants may require the inbound raw material to meet a second raw material specification such as raw material of a specific minimum-required purity. A third one of the chemical plants may require the inbound raw material to meet a third raw material specification, such as raw material of a specific grain size within a specific tolerance margin. Correspondingly, the functionality of the central management device may be used repeatedly to generate more than one validation result, and each of the number of process control systems may be configured to check use a respective one of the more than on validation results that corresponds to the associated chemical plant. That is, in the example, the central management device may generate a first validation result indicating acceptance or rejection of the inbound raw material in accordance with the first raw material specification, and may generate a second validation result indicating acceptance or rejection of the inbound raw material in accordance with the second raw material specification, and a third validation result indicating acceptance or rejection of the inbound raw material in accordance with the third raw material specification. The process control system for controlling the first chemical plant may control the first chemical plant to start feeding the inbound raw material if and only if the first validation result indicates acceptance of the inbound raw material. The process control system for controlling the second chemical plant may control the second chemical plant to start feeding the inbound raw material if and only if the second validation result indicates acceptance of the inbound raw material.

A respective device, such as the central acquisition device and the central management device, may be implemented in hardware and/or in software. If said entity is implemented in hardware, it may be embodied as a device, e.g. as a computer or as a processor or as a part of a system, e.g. a computer system. If said entity is implemented in software, it may be embodied as a computer program product, as a function, as a routine, as a program code or as an executable object.

More particularly, at least portions of the central management device may be embodied by an enterprise resource planning (ERP) system configured and programmed to embody the functionality of the central management device.

In particular, a “process control system” may refer to a digital system configured to control and monitor the operation of the respective chemical plant. The process control system may comprise a number of field devices distributed throughout the chemical plant, a number of operator stations and a number of engineering stations. The field devices may comprise sensors, actors, programmable logic devices, embedded computing devices and the like. The operator stations and the engineering stations may comprise programmable logic devices, general purpose computing devices, and the like. More particularly, a process control system may be characterized by exhibiting time deterministic behavior and by having a common data basis for all system components (field devices, operator stations and engineering stations). Time deterministic behavior may be achieved by executing a plurality of user programs/control programs in task cycles having a predetermined length.

In particular, the central management system may provide the validation result, and may optionally also provide the raw material parameters, to some or all of the number of process control systems. For example, the central management device may be configured to transmit respective signals comprising said information to the number of process control systems. Alternatively, the central management device may be configured to store said information in its database, and the plurality of process control systems may directly or indirectly fetch said information from the database. “Indirectly fetching” may comprise fetching said information from a replica of said database.

In the present disclosure, the term “a number of” means a number of one or more.

In the present disclosure, the terms “central” or “centrally provided” may refer to functionally that is provided only once or only a limited number of times for the site of the number of chemical plants. In particular, in a case where the automated control system controls a plurality of chemical plants on the site, the central functionality of the automated control system is provided a number of times that is less than the number of chemical plants. For example, the central functionality may also be provided twice to provide for a redundant fail-over configuration, or the like. In other words, the term “central” may refer to any functionality of which no further instance needs to be added when a further chemical plant is added to the site.

According to an embodiment, the central management device is further configured to initiate an analysis of the inbound raw material in a laboratory and generate the validation result further based on a result of the laboratory analysis.

Thereby, a confidence in the raw material properties can be improved.

The result of the laboratory analysis may comprise updated raw material properties that replace the raw material properties that were derived from the certificate.

For example, the laboratory analysis may be initiated in a case where there is doubt as to an accuracy of the raw material properties that were derived from the human-readable certificate. For example, the laboratory analysis may be initiated when the raw material properties are near the borders of a tolerance range specified by the raw material specifications. Alternatively, for example, the laboratory analysis may be initiated on random basis.

According to a further embodiment, the number of raw material properties comprises at least an identifier identifying a lot and a type of the inbound raw material and a number of physico-chemical properties of the inbound raw material.

The identifier is advantageously used to unambiguously identify the raw material lot to which the raw material properties apply. That is, for example, the respective process control system may use the identifier to identify whether the inbound raw material is a type of raw material required by the chemical reaction of the respective chemical plant, and the process control system may use the identifier to initiate feeding of the proper raw material from the identified lot.

For example, the identifier identifying a lot and a type of the raw material (also simply referred to as “identifier”) may be an order number used for ordering the raw material at a suppler. For example, the order number may be used to enquire the type of the raw material with an enterprise resource planning system, which may be the central management device. Alternatively, the identifier itself may include information on the type of the raw material.

Examples of the physico-chemical properties of the inbound raw material include a content of a reagent comprised in the raw material, a grain size of the raw material, a pH value of the raw material, an acidity of the raw material, such as a KOH content, a neutralization number, an acid number, and the like.

Accordingly, based on the physico-chemical properties that are derived from the certificate, it may advantageously be possible to properly control and/or optimize the production processes, i.e., the chemical reactions conducted in the individual chemical plants.

According to a further embodiment, the certificate is a QR code; and the central acquisition device is configured to acquire the QR code and derive the raw material properties by extracting the raw material properties from the acquired QR code and/or by extracting a specification of a network site from the acquired QR code and downloading the raw material properties from the specified network site.

That is, an electronic interface for providing raw material properties to the site of the chemical plant is proposed that uses industry standard technology such as QR codes and network downloads, such as HTTPS, SFTP or FTPS downloads, application programming interface (API) calls or other protocols. An operator of a site of the number of chemical plants may negotiate with its raw material suppliers to provide the raw material properties of the inbound raw materials in a downloadable data format and supply a QR code pointing to a network site hosting the downloadable data as a novel type of inbound Certificate of Analysis. Advantageously, automated transfer of raw material properties without human intervention from a raw material supplier to a raw material recipient is facilitated. Human intervention may not be required to validate the raw material properties and accept the inbound raw material.

According to a further embodiment, the certificate is an electronic mail; and the central acquisition device is configured to derive the raw material properties by parsing the electronic mail.

That is, an electronic interface for providing raw material properties to the site of the chemical plant is proposed that uses industry standard technology such as e-mail. The central acquisition device may use pattern recognition or the like to parse the electronic mail. Alternatively, the electronic mail may be pre-structured information such as XML data or the like, and the central acquisition device may use an XML parser to parse the electronic mail and extracted the raw material properties therefrom. Thereby, advantageously, automated transfer of raw material properties without human intervention from a raw material supplier to a raw material recipient is facilitated. No human intervention may be required to validate the raw material properties and accept the inbound raw material.

According to a further embodiment, the certificate is a file containing a graphical representation of a paper document; and the central acquisition device is configured to perform optical character recognition on the graphical representation of the paper document contained in the file and to derive the raw material properties by parsing an output of the optical character recognition.

The parsing of the output of the optical character recognition may be similar to the parsing of the electronic e-mail described hereinabove.

That is, even in a case where a supplier provides a Certificate of Analysis as scanned paper documents, PNG images, PDF documents or the like, or in a case where a supplier provides a Certificate of Analysis in paper form and the paper document is scanned on-site by the central acquisition device, automated transfer of the raw material properties without human intervention from the supplier to the recipient is facilitated. No human intervention may be required to validate the raw material properties and accept the inbound raw material.

According to a further embodiment, the automated control system further comprises: an interface device for interfacing the central management device with the number of process control systems, a first communication network connecting the interface device to the central management device, and a second communication network connecting the interface device to a respective process control system, additionally or alternatively the first communication network may be isolated from the second communication network. Isolation may be understood as logical isolated. Isolated may refer to a state, where the interface device may control data exchange between the first communication network and the second communication network.

Use of the interface devices advantageously improves a level of safety and security of the process control system. I.e., the interface device may advantageously block direct data transmissions to the process control systems, which may be untimely, corrupted or malicious direct data transmissions.

In particular, the first communication network may be industry-standard Ethernet, such as a local area network at the site of the chemical plants.

More particularly, each of the process control systems may be connected to the interface device by a different second communication network, and the second communication networks may be isolated from the first communication network and from each other.

In particular, any two networks being “isolated” from each other may refer to a configuration in which participants of the first network are not able exchange direct data transmissions with participants of the second network. Wherein data transmission via an interface device may not be direct data transmission. For example, any device connected to both the first network and the second network, such as the interface device, may not forward data packets between the first network and the second network. Alternatively, such a device may forward such data packets only on the condition that the data packet successfully passes a set of firewalling rules.

For example, in an ANSI/ISA-95 layered automation model, the respective process control system may be at level 2, the central management device may be at level 4, and the interface device may be at level 3 or between level 3 and level 4. According to ANSI/ISA-95, only neighboring levels may be allowed to exchange data transmissions.

According to a further embodiment, the central management device is configured to store the derived raw material properties, the comparison result and the validation result in the database of the central management device, and the interface device comprises a further database and is configured to periodically replicate at least a portion of the database of the central management device with the further database, and the interface device is further configured to provide the respective process control systems with access to the further database.

The proposed interface device advantageously provides a safe and secure way of providing data, such as the raw material properties, the comparison result and the validation result, from the central management device to the respective process control system. That is, data is fetched by, rather than transmitted to, the process control systems. The first and the second communication network may be completely isolated. Further, in case of frequent fetch operations, the further database advantageously reduced a load on the central management device.

In particular, the further database may be an in-memory database constantly held in random access memory in its entirety. Thereby, performance may be improved even further.

According to a further embodiment, the respective process control system is configured to control the respective chemical reaction based on a respective recipe; and the central management device is further configured to, if the validation result indicates acceptance of the inbound raw material, amend each of the recipes that relates to the inbound raw material based on the comparison of the raw material properties with the raw material specifications. In an example the recipe may be amended by increasing and or reducing amounts of raw materials based on their properties.

Thereby, advantageously, manual adjustments after the detection of unwanted variations of the chemical reaction or the product properties may be avoided, and a first time pass rate may be advantageously increased.

Herein, a “recipe” refers to a set of parameters under which the chemical conduction in the respective chemical plant is to be conducted. For example, the recipe may specify amounts of the raw materials of the chemical reaction. For example, the recipe may specify reaction parameters such as a temperature, a volume, a pressure, a pH value and the like. Recipe may further relate to a synthesis specification for synthesizing a molecule in particular a polymer.

For example, if a content of a reagent in the raw material deviates from a set point content of the reagent specified in the raw material specifications, the recipe may be amended by increasing or decreasing the amount of the inbound raw material to be fed into the chemical plant accordingly to maintain a desired amount of reagent. For example, if an acidity of the raw material deviates from a set point acidity as specified in the raw material specifications, the recipe may be amended to specify addition of an acid or a base, so as to maintain a desired pH value. Amending the recipe allows the use of raw material that may otherwise be rejected. This reduces waste production. In addition, amendment of the recipe results in consistent product quality of the produced product. This in turn reduces waste production. Furthermore, this allows maintaining of the reaction process. These reaction processes are highly optimized for throughput and energy savings. Consequently, amending the recipe leads to a more environmentally friendly production.

The recipe may be stored in either or both of the respective process control system and the central management device. For example, the central management device may amend the recipe by transmitting an updated recipe to the process control system, and/or by writing an updated recipe to its database and the process control systems regularly fetching the updated recipes from the further database of the interface device.

According to a further embodiment, the central management device is further configured to: generate, for at least one of the chemical plants in which a chemical reaction is to be conducted that yields a product to be delivered to an external recipient, a certificate indicating product properties of the product based at least in part on the number of raw material properties of the inbound raw material, and cause transmission of the generated human-readable certificate to the external recipient.

The certificate indicating product properties of the product may also be referred to as “outbound certificate” or “outbound Certificate of Analysis”. The outbound certificate may be any of the types of certificate that were described for the inbound certificate hereinabove.

Thereby, advantageously, information from the inbound certificate may be used in generating the outbound certificate. An amount of analysis that needs to be carried out on the outbound product to generate the outbound certificate may be reduced.

Merely as an example, if, according to the inbound certificate, the inbound raw material contains a softening agent and/or one of several inbound raw materials is a softening agent, the outbound certificate may specify that also the product contains the softening agent, thereby indicating that the product is not to be used for the manufacturing of baby bottles.

As a further example, if, according to the inbound certificate, all inbound raw materials adhere to a requirement such as “kosher” or “vegane”, the outbound certificate may specify that also the product adheres to said requirement.

As a further example, if the inbound certificate(s) of the inbound raw material(s) specify a carbon dioxide footprint of the raw material, the outbound certificate may specify the carbon dioxide footprint of the product. The carbon dioxide footprint may be calculated by the central management device by adding up the carbon dioxide footprints of all inbound raw materials and an amount of carbon dioxide emitted while producing the product.

That is, the product properties of the product may be determined based on the number of raw material properties of the inbound raw material and further based on data relating to the processing in the chemical plant or plants (10-13) that are involved in producing the product.

According to a further embodiment, the central management device is further configured to amend at least one of the raw material specifications stored in the database of the central management device based on: the raw material properties of the inbound raw material, and a result of the chemical reaction performed in at least one of the chemical plants using the inbound raw material as a raw material.

Thereby, advantageously, a first time pass rate may be improved, a product quality may be improved and/or a cost of the inbound raw material may be reduced.

Herein, the “result of the chemical reaction” may be a product property, that may be obtained by analyzing the product produced by the chemical reaction, such as in a laboratory. The “result of the chemical reaction” may be a quantity observed at the chemical plant while conducting the chemical reaction, such as a reaction temperature, a reaction pressure, a yield rate, and the like. The “result of the chemical reaction” may also be a quantity obtained by monitoring and analyzing any of the above during the chemical reaction or after the chemical reaction has finished. For example, the “result of the chemical reaction” may also be a first time pass rate or the like.

Predictive quality assurance, Big Data analysis and similar models may be used to amend the raw material specifications.

For example, if it is determined that inbound raw materials with raw material properties that are close to the borders of a tolerance range specified by the raw material specifications lead to acceptable product properties, the tolerance range may be automatically widened. If, on the other hand, it is determined that inbound raw materials with raw material properties that are well within the tolerance range still yield poor product properties, the tolerance range may be automatically narrowed.

Any embodiment of the first aspect may be combined with any embodiment of the first aspect to obtain another embodiment of the first aspect.

According to a second aspect, the object is solved by a chemical park comprising the automated control system of the first aspect and/or its embodiments and the number of chemical plants, wherein the number of chemical plants is greater than one.

For example, in the chemical park, the number of chemical plants may be interconnected, at least some of the chemical plants may be operable to conduct a different chemical reaction, and a product of the chemical reaction of at least one of the chemical plants may be a raw material of the chemical reaction of another one of the chemical plants. In particular, the chemical plants may be interconnected so as to enable automated transport of the product of the one chemical plant to the other chemical plant where the product serves as a raw material. For example, the chemical plants may be interconnected by conveyors, pipes or the like. Such a chemical park may also be called a “verbund site”.

The embodiments, definitions, features and advantages described for the control system of the first aspect also apply to the chemical park of the second aspect.

According to an embodiment, in the chemical park, the central acquisition device, the central management device and the interface device are provided centrally for the entire chemical park, and the respective process control systems are provided individually for the respective chemical plants.

By centralizing the automated acquisition of inbound human-readable certificates of raw material properties, it may be possible to reduce workload, increase traceability, and enable further data analysis and insight. Thereby, it may be possible to achieve higher first time pass rates, lesser cost for raw material, better product quality and the like.

According to a third aspect, the object is solved by an automated control method for controlling production in a number of chemical plants. The automated control method comprises: using a central acquisition device to: acquire a certificate indicating a number of raw material properties of an inbound raw material that has been delivered to a site of the number of chemical plants, and derive the raw material properties from the certificate. The automated control method further comprises using a central management device to: compare the derived raw material properties with a corresponding one of a number of raw material specifications stored in a database of the central management device, and generate a validation result indicating acceptance or rejection of the inbound raw material. The automated control method further comprises using a number of process control systems for controlling a respective chemical reaction to be conducted in a respective one of the chemical plants to: if the validation result indicates acceptance of the inbound raw material, control the corresponding chemical plant to start feeding the inbound raw material.

Enables control of plant based on availability of suitable product->hence more efficient use of raw material.

In an embodiment, the corresponding chemical plant is selected based on the validation result. This allows to manage the raw material resources in an efficient manner.

The embodiments, definitions, features and advantages described for the control system of the first aspect and/or the chemical park of the second aspect also apply to the control method of the third aspect.

According to a fourth aspect, the object is solved by a computer program product comprising a number of program codes for executing the method of the third aspect when run on the central acquisition device, the central management device and the number of process control systems, respectively.

A computer program product, such as a computer program means, may be embodied as a memory card, USB stick, CD-ROM, DVD or as a file which may be downloaded from a server over a communication network.

Further possible implementations or alternative solutions of the invention also encompass combinations—that are not explicitly mentioned herein—of features described above or below in regard to the embodiments. The person skilled in the art may also add individual or isolated aspects and features to the most basic form of the invention.

Further embodiments, features and advantages of the present invention will become apparent from the subsequent description and dependent claims, taken in conjunction with the accompanying drawings, in which:

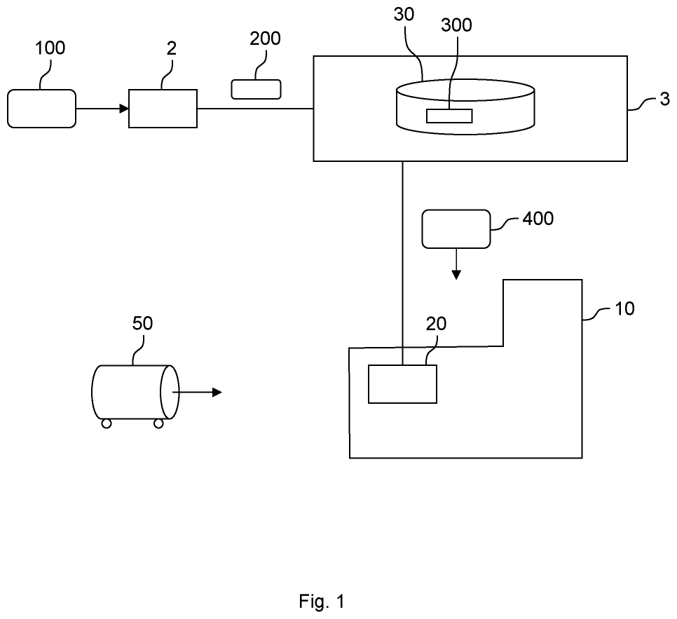

FIG. 1 schematically visualizes an automated control system of a chemical plant according to a first exemplary embodiment;

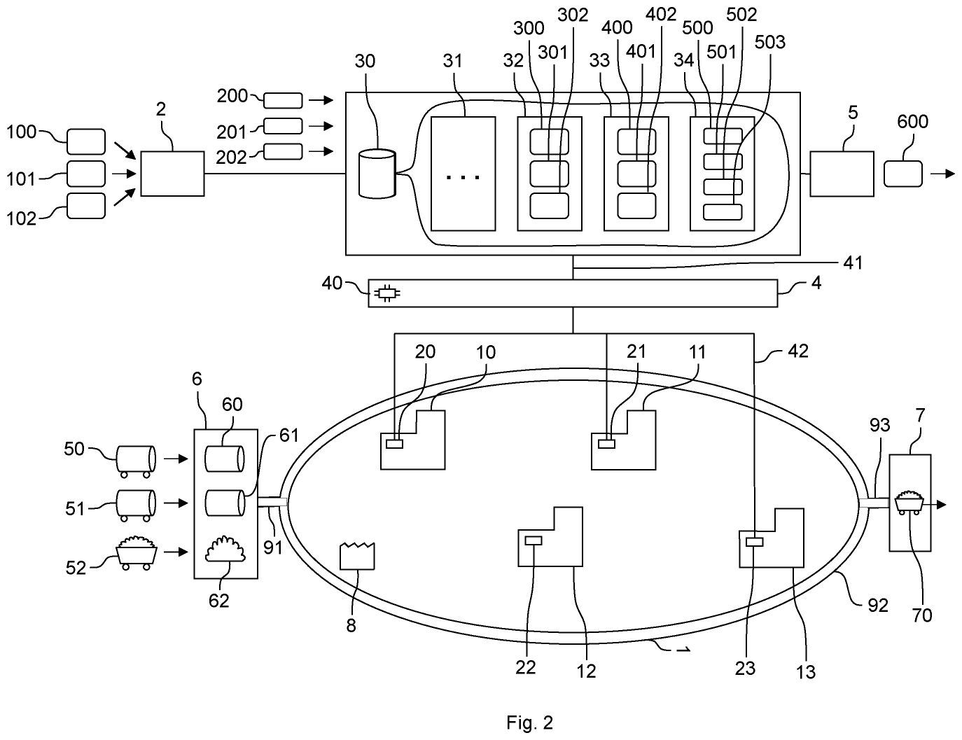

FIG. 2 schematically visualizes a chemical park according to a second exemplary embodiment; and

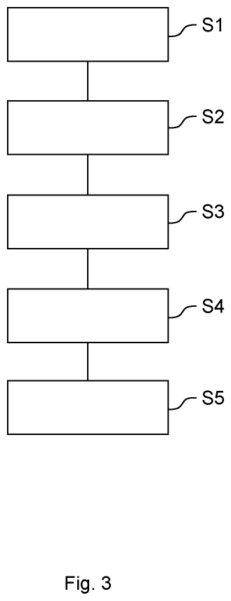

FIG. 3 schematically visualizes an automated control method according to exemplary embodiments.

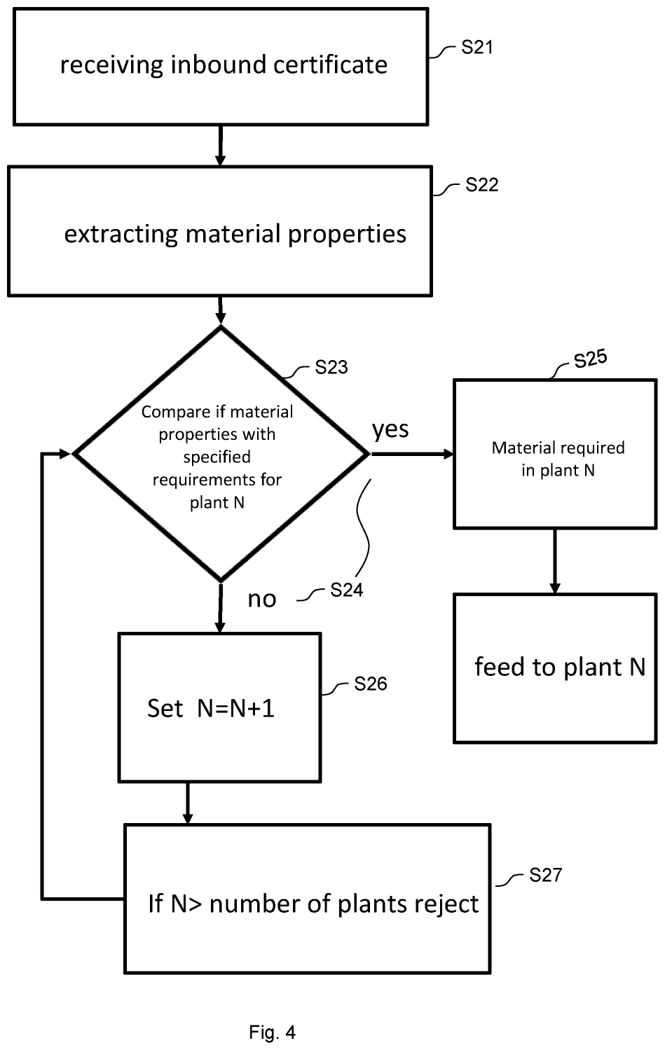

FIG. 4 schematically illustrates a further embodiment of the method depicted in FIG. 3

FIG. 1 schematically visualizes an automated control system 2, 3, 20 of a chemical plant 10 according to a first exemplary embodiment. FIG. 3 schematically visualizes an automated control method according to exemplary embodiments. The first exemplary embodiment will be described with reference to FIG. 1 and FIG. 3.

The chemical plant 10 is equipped with a process control system 20. The process control system 20 performs control and operation of the chemical plant 10. It exhibits time-deterministic behavior and has a common data basis (not shown) for all its components.

At least portions of the process control system 20 form a part of a proposed automated control system. Furthermore, the proposed automated control system comprises the central acquisition device 2 and the central management device 3.

When inbound raw material 50 is delivered to the site of the chemical plant 10, it is accompanied by a Certificate of Analysis 100 (example of an inbound certificate indication raw material properties of the inbound raw material 50) that is delivered to the site, such as, for example, electronically.

In step S1, the inbound Certificate of Analysis 100 may be received by a central acquisition device 2, for example by electronic mail, via HTTP, via an application programming interface (API), by scanning a paper document, by photographing a QR code, or the like.

In step S2, the central acquisition device 2 may extract information from the acquired inbound Certificate of Analysis 100 and may derive the raw material properties 200 of the raw material 50 from the extracted information. The raw material properties 200 may comprise structured machine-readable data that is provided to the central management device 3.

In step S3, the central management device 3 may compare the derived raw material properties 200 with a raw material specification 300 that is stored in a database 30 of the central management device 3. In this way, the central management device 3 checks whether the inbound raw material 50 complies with the requirements that are specified for of a chemical reaction to be conducted in the chemical plant 10. For example, the central management device 3 can compare a content of a reagent against a set point content specified as part of the raw material specification 300.

In step S4; based on the comparison of step 3, the central management device 3 generates a validation result 400. The validation result 400 indicates whether the raw material 50 is accepted or rejected. The validation result 400 and at least a part of the raw material properties are provided to the process control system 20.

In step S5, the process control system 20 checks, based on the raw material properties, which include at least a type of the raw material, whether the raw material 50 is a raw material required by the chemical reaction to be conducted in the chemical plant 10. Further, the process control system 20 checks whether the validation result 400 indicates acceptance of the raw material 50. If both checks are affirmative, the process control system 20 starts feeding the inbound raw material 50 into the chemical plant 10.

If, on the other hand, the validation result 400 indicates rejection of the inbound raw material 50, the process control system 20 will not start feeding the inbound raw material 50 into the chemical plant 10. Furthermore, the central management device 3 may initiate proper steps to either discard the inbound raw material 50, to return the inbound raw material 50 to its supplier, or the like.

In a modification of the first exemplary embodiment, the central management device 3 checks whether the raw material 50 is a raw material required by the chemical reaction to be conducted in the chemical plant 10. Only if this check is affirmative, the central management device 3 provides the validation result 400 to the process control system 20. When the process control system 20 receives the validation result 400 and the validation result 400 indicates acceptance of the inbound raw material 50, the process control system 20 starts feeding the inbound aw material 50 into the chemical plant 10.

In a further modification, the central management device 3 checks both wehter the raw material 50 is a raw material required by the chemical reaction to be conducted in the chemical plant 10, and if the validation result 400 indicates acceptance of the raw material 50. Only if both checks are affirmative, the central management device 3 provides the validation result 500 to the process control system 20. In this modification, whenever the process control system 20 receives the validation result 400, it starts feeding the inbound raw material 50 into the chemical plant 10.

FIG. 2 schematically visualizes a chemical park 1 according to a second exemplary embodiment. The second exemplary embodiment is based on the first exemplary embodiment. Elements that correspond to elements of the first exemplary embodiment have the same reference numbers, and detailed descriptions thereof may be shortened and/or omitted.

The chemical park 1 is a so-called “verbund site” that comprises a number of chemical plants 10, 11, 12, 13. Each of the chemical plants 10-13 is equipped with a respective process control system 20, 21, 22, 23. The chemical park 1 also comprises an inbound warehouse 6, an outbound warehouse 7 and a laboratory 8. It is noted that a specific laboratory 8 is shown in FIG. 2, however, it is conceivable that more than one laboratory may be present. The inbound warehouse 6, the chemical plants 10-13, the outbound warehouse 7 and the laboratory 8 are interconnected by piping and/or conveyors 91-93 or the like to facilitate transport of chemical raw materials, or educts, and chemical products between the warehouses 6, 7, the laboratory 8 and the chemical plants 10-13.

The chemical park 1 also comprises an automated control system, that is embodied by at least portions of the process control systems 20, 21, 22, 23, a central acquisition device 2, a central management device 3 an interface device 4, and a central output device 5.

The central acquisition device 2, the central management device 3, the interface device 4 and the central output device 5 are connected to a first communication network 41. The process control systems 20-23 of the chemical plants 10-13 and the interface device 4 are connected to a second communication network 42. The only device connected to both communications networks 41, 42 is the interface device 4. However, the interface device 4 does not forward data transmissions from the communication network 41 into the communication network 42, or vice versa. Thereby, the first communication network 41 and the second communication network 42 are isolated from each other.

Thereby, a safe and secure ANSI/ISA-95 compliant layered automation model is realized, in which the process control systems 20, 21, 22, 23 are at level two, the central management device 3 is at level four and the interface device 4 constitutes an interface between levels two and three. At level three (not shown in FIG. 2), a number of Manufacturing Execution System (MES), a Plant Information Management System (PIMS) and the like may be provided. The MES and the PIMS are not essential. However, it is noted that part or all of the functionality attributed herein to the process control systems 20, 21, 22, 23 may also be embodied in part or in full and/or may be controlled, in part or in full, by a PIMS and/or a MES.

The central management device 3 of the present exemplary embodiment is an Enterprise Resource Planning system that is specifically configured and programmed as described hereinbelow. The central management device 3 will be referred to as “ERP system 3”.

FIG. 2 shows three deliveries of inbound raw material 50, 51, 52 that are being delivered to the site of the chemical park 1. At the chemical park 1, the inbound raw material 50, 51, 52 are automatically offloaded into the inbound warehouse 6, where they are stored as lots 60-62 that can also be referred to as Quality Inspection Stocks 60, 61, 62 (further examples of the inbound raw materials). That is, a Quality Inspection Stock 60-62 is a raw material 50, 51, 52 stored in the inbound warehouse 6 and awaiting acceptance or rejection.

The inbound raw materials 50, 51, 52 are accompanied by corresponding inbound Certificates of Analysis 100, 101, 102 that are delivered electronically to the central acquisition device 2. The Certificate of Analysis 100 is a QR code. The Certificate of Analysis 101 is an e-mail comprising human-readable text and/or XML code. The Certificate of Analysis 102 is a PDF document.

The central acquisition device 2 extracts digital information from the respective Certificates of Analysis 100-102. In the case of the QR code 100, the central acquisition device 2 extracts a URL from QR code 100, contacts a network site indicated by the URL and downloads the raw material properties 200 of the raw material 50. In the case of the e-mail 101, the central acquisition device 2 uses pattern recognition on the human readable text and/or parses the XML code embedded in the e-mail 101 to obtain the raw material properties 201 of the raw material 51. In the case of the PDF document 102, the central acquisition device 2 performs optical character recognition and parses, using pattern recognition, the result of the optical character recognition to obtain the raw material properties 202 of the raw material 52.

Herein, each of the raw material properties 200-202 comprise an order number under which the corresponding lot 60, 61, 62 of the raw materials 50, 51, 52 was ordered. Furthermore, each of the raw material properties 200-202 comprise one or more physico-chemical properties of the raw materials 50, 51, 52.

The raw material properties 200-202 derived in this manner are provided to the ERP system 3.

The ERP system 3 uses the respective order numbers to obtain, from a non-shown region of the database 30, the raw material types that were ordered using the respective order numbers, and includes the obtained raw material types into the raw material properties 200-202.

In a modification, the raw material properties 200-202 may include, in addition to the order number identifying the lots 60, 61, 62, an indication of the raw material type of the raw materials 50, 51, 52. In this case, the ERP system 3 does not need to obtain the raw material types based on the order number.

The raw material properties 200-202 are stored in a first region 31 of the database 30 of the ERP system 3.

The ERP system 3 then compares the raw material properties 200-202 stored in the first memory region 31 of the database 30 with corresponding raw material specifications 300-302 stored in a second memory region 32 of the database 30.

If a result of the comparison is questionable, unsatisfactory, and/or on a random basis for monitoring purposes, the ERP system 3 may initiate an analysis of one of the Quality Inspection Stocks 60-62 (raw material) in the laboratory 8 (in one of the laboratories, if plural laboratories are present). The ERP system 3 may then obtain updated raw material properties from the laboratory 8 that replace the raw material properties 200-202 that were derived from the inbound Certificate of Acceptance 100-102 in the first memory region 31 of the database 30. Thereupon, the ERP system 3 may repeat the comparison based on the updated raw material properties.

Based on the result of the comparison, the ERP system 3 generates validation results 400-402 that indicate acceptance or rejection of the corresponding raw material 50-52. A validation result 400-402 that indicates acceptance of the corresponding raw material 50-52 can also be referred to as a Usage Decision 400-402 for the corresponding Quality Inspection Stock 60-62. In the example shown in FIG. 2, all Quality Inspection Stocks 60-62 are accepted, therefore all validation results 400-402 constitute Usage Decisions 400-402. The Usage Decisions 401-402 are stored in a third memory region 33 of the database 30.

Furthermore, the database 30 of the ERP system 3 has a fourth memory region 44 which stores respective recipes 500-503 corresponding to each of the chemical plants 10-13 and specifying reaction parameters, such as temperature, pressure, raw material amounts and the like, for the chemical reactions to be conducted in the respective chemical plants 10-13.

In the present exemplary embodiment, the ERP system 3, when comparing the raw material properties 200-202 of the inbound raw materials 50-52 with the raw material specifications 300-302, uses a respective comparison result to amend the corresponding recipes 500-503. That is, for each comparison, all recipes 500-503 that refer to the corresponding raw material properties 200-202 are amended.

For example, let us assume that the chemical reactions to be conducted in the chemical plants 10 and 12 each consume the raw material 51 as an educt, and that the raw material 51 has a lesser content of a reagent than specified by the corresponding raw material specification 301, but is still with the tolerance range specified by the raw material specification 301. In this case, a Usage Decision 401 is made, and the recipes 500 and 502 corresponding to chemical plants 10 and 12 are each amended by increasing the amount of the raw material 51 specified therein so as to attain the specified net content of the reagent.

The interface device 4 comprises an in-memory data base 40. The interface device 4 periodically synchronizes the content of the in-memory database 40 at least with the shown memory regions 31-34 of the database 30 of the central management device 3, and provides the process control systems 20-23 of the chemical plants 10-13 with access to the further database 40.

The process control systems 20-23 of the chemical plants 10-13 periodically fetches portions of the one or more of the raw material properties 200-202, Usage Decisions 300-302, and recipes 500-504 from the in-memory database 40 of the interface device 4 as and when required.

When a process control system 20-23 detects a Usage Decision 300-302 relating to an inbound raw material 50-52 that is consumed by the chemical reaction to be conducted in the corresponding chemical plant 10-13, the process control system 20-23 starts feeding of the raw material 50-52 from the corresponding lot 60-62 into the corresponding chemical plant 10-13. Once all raw materials 50-52 required by the respective chemical reaction are loaded into the respective chemical plant 10-13, the respective chemical reaction is conducted and a product is produced. The product is analysed, for example in laboratory 8, and product properties of the product are stored in the first memory region 31 of the database 30 of the ERP system 3.

Some of the chemical plants 10-13 may produce a product that is used as a raw material for another one of the chemical plants 10-13. In this case, the product properties that get stored in the first memory region 31 of the database 30 constitute further raw material properties 200-202.

Such intermediate products may be transferred, by pipe or conveyor 93, from one of the chemical plants 10-13 to another one of the chemical plants 10-13. Alternatively, intermediate products may be transferred back to the inbound warehouse 6 to form a further Quality Inspection Lot awaiting an acceptance Usage Decision 400-402 to be made based on its product properties.

At least one of the chemical plants 10-13 produces a final product 70 that is to be delivered to an external recipient. The final product 70 is transferred, via pipes or conveyors 92, 93, to the outbound warehouse 7, where it awaits delivery or from where it is delivered to the external recipient.

For the final product 70, the ERP system 3 generates an outbound Certificate of Analysis 600, which is an example for a certificate indicating the product properties of the final product 70. As mentioned above, some of the product properties indicated by the outbound Certificate of Analysis 600 may be obtained by analysis of the final product 70, such as in laboratory 8. However, one or more further product properties indicated by the outbound Certificate of Analysis 600 are generated, without analyzing the product 70, based on the raw material properties 200-202 of the raw materials that were used in producing the final product and/or an intermediate product from which the final product was produced. In other words, raw material properties that were indicated by the inbound Certificates of Analysis 100-102 of the inbound raw materials 50-52 may be tracked throughout the chemical park 1, may be converted according to known properties of the respective chemical reactions, and may be used to specify product properties that are indicated in the outbound Certificate of Analysis 600 of the final product 70. The central output device 5 is used to transmit the outbound Certificate of Analysis 600 to the recipient of the final product 70. The central output device 6 may be a printer, an e-mail sending device, an API client, or the like.

Over time, a large amount of raw material properties 200-202, product properties, analysis results, other data generated by the process control system 20-23 and the like is accumulated in the database 30 of the ERP system 3. The ERP system 3 may use data analysis tools such as Big Data, predictive analysis and the like to automatedly amend the raw material specifications 300. For example, the raw material specifications 300-302 may be widened to allow for cheaper sourcing of the inbound raw materials 50-52, or the raw material specifications 300-302 may be narrowed to enable a high quality of the final products 70. Data analysis tools may also be used to optimize parameters of the chemical reactions that are conducted at the chemical plants 10-13, such as parameters used by the process control systems 20-23, and/or to modify parameters used by the ERP system 3, for example to increase or decrease the frequency and/or likelihood of laboratory analyses that are carried out on inbound raw materials 50-52 and/or on products 70 produced by the chemical plants 10-14, and the like.

Although the present invention has been described in accordance with preferred exemplary embodiments, it is obvious for the person skilled in the art that modifications are possible in all embodiments.

For example, the second embodiment discloses a single central laboratory 8 that is used by the entire chemical park 1. However, instead of or in addition to the central laboratory 8, the chemical park 1 may comprise a plurality of laboratories. For example, in a typical scenario, each chemical plant 10-13 may have a respective laboratory installed on-site at the respective chemical plant 10-13. Alternatively, for example, a first number of chemical plants 10-13 may share a first laboratory, and a second number of the chemical plants 10-13 may share a second laboratory. In other words, each of several organizational departments of a verbund site may have its own laboratory.

In particular, the laboratory 8, or each of the plurality of laboratories, may be equipped with a respective laboratory management device, which may be embodied as a Laboratory Information Management System, LIMS. The respective LIMS may be connected with the ERP system 3, for example using the first communication network 41. In this way, results of an analysis performed in the one or more laboratories (updated raw material properties, product properties, and the like) may be made available in the database 30 of the ERP system 3 to be used by the ERP system 3 and/or the by the respective process control system for generating comparison results, validation results, product property certificates, amending recipes, and the like.

For example, the second exemplary embodiment discloses that all inbound raw material 50-52 arrives at a central inbound warehouse 6. However, similar to the first embodiment, also in the second exemplary embodiment, some or all of the inbound raw material 50-52 may also be delivered directly to a respective storage facility, such as a tank or the like, installed at the respective site of the respective one or more of the chemical plants 10-13.

FIG. 4 illustrates a further embodiment of the method disclosed with reference to FIGS. 1 to 3. In step S21, the inbound Certificate of Analysis 100 may be received by a central acquisition device 2, for example by electronic mail, via HTTP, via an application programming interface (API), by scanning a paper document, by photographing a QR code, or the like.

In step S22, the central acquisition device 2 may extract information from the acquired inbound Certificate of Analysis 100 and may derive the raw material properties 200 of the raw material 50 from the extracted information. The raw material properties 200 may comprise structured machine-readable data that is provided to the central management device 3.

In step S23, the central management device 3 may compare the derived raw material properties 200 with a raw material specification 300 that is stored in a database 30 of the central management device 3. In this way, the central management device 3 checks whether the inbound raw material 50 complies with the requirements that are specified for of a chemical reaction to be conducted in the chemical plant 10. For example, the central management device 3 can compare a content of a reagent against a set point content specified as part of the raw material specification 300.

In step S24; based on the comparison of step S23, the central management device 3 generates a validation result 400. The validation result 400 indicates whether the raw material 50 is accepted or rejected. The validation result 400 and at least a part of the raw material properties are provided to the process control system 20.

In step S25, the process control system 20 checks, based on the raw material properties, which include at least a type of the raw material, whether the raw material 50 is a raw material required by the chemical reaction to be conducted in the chemical plant 10. Further, the process control system 20 checks whether the validation result 400 indicates acceptance of the raw material 50. If both checks are affirmative, the process control system 20 starts feeding the inbound raw material 50 into the chemical plant 10.

If, on the other hand, the validation result 400 indicates rejection of the inbound raw material 50, the process control system 20 will not start feeding the inbound raw material 50 into the chemical plant 10. Furthermore, the central management device 3 may initiate proper steps to either discard the inbound raw material 50, to return the inbound raw material 50 to its supplier, or the like.

In a modification of the first exemplary embodiment, the central management device 3 checks whether the raw material 50 is a raw material required by the chemical reaction to be conducted in the chemical plant 10. Only if this check is affirmative, the central management device 3 provides the validation result 400 to the process control system 20. When the process control system 20 receives the validation result 400 and the validation result 400 indicates acceptance of the inbound raw material 50, the process control system 20 starts feeding the inbound aw material 50 into the chemical plant 10.

In a further modification, the central management device 3 checks both whether the raw material 50 is a raw material required by the chemical reaction to be conducted in the chemical plant 10, and if the validation result 400 indicates acceptance of the raw material 50. Only if both checks are affirmative, the central management device 3 provides the validation result 500 to the process control system 20. In this modification, whenever the process control system 20 receives the validation result 400, it starts feeding the inbound raw material 50 into the chemical plant 10.

In this example, if the validation result 400 indicates a rejection of the inbound raw material 50 based on the comparison step S23, where the central management device 3 may compare the derived raw material properties 200 with a raw material specification 300 that is stored in a database 30 of the central management device 3. Where the central management device 3 checks whether the inbound raw material 50 complies with the requirements that are specified for of a chemical reaction to be conducted in the chemical plant 10.

Step S24 may generate a “no” signal. In Step S26 another chemical plant may be selected, e.g. by increasing a denominator referring to chemical plants. Step 23 may then be reiterated with respect to another chemical plant, e.g. plant 11. This loop may be performed until either the raw material is approved for one chemical plant or finally rejected. In an optional step S27 it may be assessed if step S23 has been performed for all suitable chemical plants. If so, the raw material may be rejected.

An advantage of exemplary embodiments of the present disclosure is that in a chemical park, inbound Certificates of Analysis are acquired automatically and centrally, raw material properties are determined automatically based on the acquired Certificates of Analysis, validation thereof and Usage Decisions can be made automatically and centrally, no human intervention is required to start feeding the raw materials into the chemical plants, and thanks to the raw material properties that are available in the central ERP system, advanced data analysis tools can be employed to automatically amend recipes of the chemical reactions as well as raw material specifications so as to increase a first time pass rate, improve the product quality and/or lower the cost of the raw materials.

Various non-limiting exemplary embodiments have been described by way of example. The scope of the present invention is defined by the appended claims.

### USED REFERENCE SIGNS

1 chemical park
2 central acquisition device
3 central management device, ERP system
4 interface device
5 output device
6 inbound warehouse
7 outbound warehouse
8 laboratory
10-13 chemical plants
20-23 process control systems
30 database
31-34 first to fourth memory region of the database
41 first communication network
42 second communication network
40 in-memory database
50-52 inbound raw material
60-62 Quality Inspection Stock, inbound raw material awaiting acceptance or rejection
70 final product
91-93 pipes and/or conveyors
100-102 certificate indicating raw material properties, inbound Certificate of analysis,
200-202 raw material properties
300-302 raw material specifications
400-402 validation results, Usage Decisions
500-503 recipes
600 certificate indicating product properties, outbound Certificate of Analysis
S1-S5 method steps
S21-S27 method steps

1. An automated control system for controlling production in a number of chemical plants, the automated control system comprising:
a central acquisition device configured to:
acquire a certificate indicating a number of raw material properties of an inbound raw material that has been delivered to a site of the number of chemical plants, and
derive the raw material properties from the certificate;
a central management device configured to:
compare the derived raw material properties with a corresponding one of a number of raw material specifications stored in a database of the central management device, and
generate a validation result indicating acceptance or rejection of the inbound raw material; and
a number of process control systems for controlling a respective chemical reaction to be conducted in a respective one of the chemical plants, the process control systems being configured to:
if the validation result indicates acceptance of the inbound raw material,
control the corresponding chemical plant to start feeding the inbound raw material.

2. The automated control system of claim 1, wherein:
the central management device is further configured to initiate an analysis of the inbound raw material in a laboratory and generate the validation result further based on a result of the laboratory analysis.

3. The automated control system of claim 1, wherein
the number of raw material properties comprises at least an identifier identifying a lot and a type of the inbound raw material and a number of physico-chemical properties of the inbound raw material.

4. The automated control system of claim 1, wherein
the certificate is a QR code; and
the central acquisition device is configured to acquire the QR code and derive the raw material properties by extracting the raw material properties from the acquired QR code and/or by extracting a specification of a network site from the acquired QR code and downloading the raw material properties from the specified network site.

5. The automated control system of claim 1, wherein
the certificate is an electronic mail; and
the central acquisition device is configured to derive the raw material properties by parsing the electronic mail.

6. The automated control system of claim 1, wherein
the certificate is a file containing a graphical representation of a human-readable paper document; and
the central acquisition device is configured to perform optical character recognition on the graphical representation of the paper document contained in the file and to derive the raw material properties by parsing an output of the optical character recognition.

7. The automated control system of claim 1, further comprising:
an interface device for interfacing the central management device with the number of process control systems,
a first communication network connecting the interface device to the central management device, and
a second communication network connecting the interface device to a respective process control system,
wherein the first communication network is isolated from the second communication network.

8. The automated control system of claim 7,
wherein the central management device is configured to store the derived raw material properties, the comparison result and the validation result in the database of the central management device, and
the interface device comprises a further database and is configured to periodically replicate at least a portion of the database of the central management device with the further database, and
the interface device is further configured to provide the respective process control systems with access to the further database.

9. The automated control system of claim 1, wherein
the respective process control system is configured to control the respective chemical reaction based on a respective recipe; and
the central management device is further configured to, if the validation result indicates acceptance of the inbound raw material, amend each of the recipes that relates to the inbound raw material based the comparison of the raw material properties with the raw material specifications.

10. The automated control system of claim 1, wherein
the central management device is further configured to:
generate, for at least one of the chemical plants in which a chemical reaction is to be conducted that yields a product to be delivered to an external recipient, a certificate of product properties of the product based at least in part on the number of raw material properties of the inbound raw material, and
cause transmission of the generated certificate to the external recipient.

11. The automated control system of claim 1, wherein
the central management device is further configured to amend at least one of the raw material specifications stored in the database of the central management device based on the raw material properties of the inbound raw material and a result of the chemical reaction performed in at least one of the chemical plants using the inbound raw material as a raw material.

12. A chemical park comprising the automated control system of claim 1 and a number of chemical plants, wherein the number of chemical plants is greater than one.

13. The chemical park of claim 12, wherein the central acquisition device and the central management device are provided centrally for the entire chemical park, and wherein the respective process control systems are provided individually for the respective chemical plants.

14. An automated control method for controlling production in a number of chemical plants, the automated control method comprising:
using a central acquisition device to:
acquire a certificate indicating a number of raw material properties of an inbound raw material that has been delivered to a site of the number of chemical plants, and
derive the raw material properties from the certificate;
using a central management device to:
generate a comparison result of comparing the derived raw material properties with a corresponding one of a number of raw material specifications stored in a database of the central management device, and
generate a validation result indicating acceptance or rejection of the inbound raw material; and
using a number of process control systems for controlling a respective chemical reaction to be conducted in a respective one of the chemical plants to:
if the validation result indicates acceptance of the inbound raw material, control the corresponding chemical plant to start feeding the inbound raw material.

15. A computer program product comprising a number of program codes for executing the method of claim 14 when run on the central acquisition device, the central management device and the number of process control systems, respectively.
